(19) United States
(12) Patent Application Publication
(10) Pub. No.: US 2016/0322900 A1
(43) Pub. Date: Nov. 3, 2016

(54) SWITCHING CONVERTER WITH ACCURATE ZERO CURRENT DETECTION AND CONTROL METHOD THEREOF

(71) Applicant: Chengdu Monolithic Power Systems Co., Ltd., Chengdu (CN)

(72) Inventor: Li Xu, Chengdu (CN)

(21) Appl. No.: 15/136,848

(22) Filed: Apr. 22, 2016

(30) Foreign Application Priority Data
Apr. 28, 2015 (CN) 201510206579.1

(51) Int. Cl. H02M 3/158; H02M 1/08

(52) U.S. Cl. CPC H02M 3/158; H02M 1/08; H02M 2001/0009

(57) ABSTRACT

A zero current detection method used in a switching converter, wherein the switching converter has a first switch, a second switch with a body diode, and a tank element. The current flowing through the tank element increases when the first switch is on and the second switch is off, and decreases when the first switch is off and the second switch is on. The zero current detection method includes: adjusting an offset signal in accordance with the on-time of the body diode in the second switch; comparing the current flowing through the tank element with the offset signal; and turning off the second switch if the current flowing through the tank element is detected to be lower than the offset signal.

### CROSS-REFERENCE TO RELATED APPLICATIONS

This application claims the benefit of CN application 201510206579.1, filed on Apr. 28, 2015 and incorporated herein by reference.

### TECHNICAL FIELD

The present invention generally relates to electronic circuits, and more particularly but not exclusively to switching converters with zero current detection.

### BACKGROUND

In synchronous Buck (step-down) converters, the low-side switch is generally turned off when the inductor current reduces to zero, so as to avoid reverse current and improve light load efficiency. The zero current detection of the inductor current is often realized by comparators, thus its accuracy would unquestionably be affected by the comparators inherent delay. This situation becomes worse especially when a small inductance is used in converters with high switching frequency.

To solve the above-mentioned problem, a traditional way is adding a fixed offset to the input of the comparator to counteract the delay. Yet such a fixed offset cannot adapt to all applications and could hardly counteract the delay once the temperature, inductance or output voltage varies.

### SUMMARY

To solve the problem mentioned above, the present invention involves an offset signal which is adjusted according to the on-time of the body diode in the low-side switch. This adaptive offset signal can effectively counteract the inherent delay of the comparator regardless of the applications and variations on the temperature, inductance or output voltage.

Embodiments of the present invention are directed to a zero current detection method used in a switching converter, wherein the switching converter has a first switch, a second switch with a body diode, and a tank element, and wherein the current flowing through the tank element increases when the first switch is on and the second switch is off, and decreases when the first switch is off and the second switch is on. The zero current detection method comprises: adjusting an offset signal in accordance with the on-time of the body diode in the second switch; comparing the current flowing through the tank element with the offset signal; and turning off the second switch if the current flowing through the tank element is detected to be lower than the offset signal.

Embodiments of the present invention are also directed to a controller used in a switching converter. The controller comprises: a freewheeling detection circuit configured to generate an offset adjusting signal in accordance with the on-time of the body diode in the second switch; an offset generator coupled to the freewheeling detection circuit and configured to generate an offset signal based on the offset adjusting signal; a zero current detection circuit coupled to the offset generator, wherein based on the offset signal and a current sensing signal indicative of the current flowing through the tank element, the zero current detection circuit generates a zero current detection signal; and a logic circuit coupled to the zero current detection circuit, wherein the logic circuit turns off the second switch if the zero current detection signal indicates that the current sensing signal is smaller than the offset signal.

Embodiments of the present invention are further directed to a switching converter comprising: a first switch having a first terminal, a second terminal and a control terminal, wherein the first terminal is configured to receive an input voltage; a second switch with a body diode, wherein the second switch has a drain terminal, a source terminal and a gate terminal, the drain terminal is coupled to the second terminal of the first switch to form a switch node, the source terminal is coupled to a reference ground; an inductor having a first terminal and a second terminal, wherein the first terminal is coupled to the switch node, and the second terminal is configured to provide an output voltage to a load; an output capacitor coupled between the second terminal of the inductor and the reference ground; a freewheeling detection circuit configured to generate an offset adjusting signal in accordance with the on-time of the body diode in the second switch; an offset generator coupled to the freewheeling detection circuit and configured to generate an offset signal based on the offset adjusting signal; a zero current detection circuit coupled to the offset generator, wherein based on the offset signal and a current sensing signal indicative of the current flowing through the inductor, the zero current detection circuit detects whether the current flowing through the inductor decreases to zero and generates a zero current detection signal; and a logic circuit coupled to the zero current detection circuit, wherein if the zero current detection signal indicates that the current flowing through the inductor decreases to zero, the logic circuit will generate a control signal to turn off the second switch.

### BRIEF DESCRIPTION OF THE DRAWING

The present invention can be further understood with reference to the following detailed description and the appended drawings, wherein like elements are provided with like reference numerals.

FIG. 1 is a block diagram of a switching converter 100 in accordance with an embodiment of the present invention.

FIG. 2 illustrates working waveforms of the switching converter 100 shown in FIG. 1 in accordance with an embodiment of the present invention.

FIG. 3 schematically illustrates curves indicating the relationship between the offset signal Voffset and the freewheeling time FRT.

FIG. 4 is a block diagram of a switching converter 200 in accordance with an embodiment of the present invention.

FIG. 5 schematically illustrates a switching converter 200A in accordance with an embodiment of the present invention.

FIG. 6 schematically illustrates a freewheeling detection circuit 201B, an offset generator 202B and a zero current detection circuit 203B in accordance with an embodiment of the present invention.

FIG. 7 schematically illustrates working waveforms of the circuits shown in FIG. 6 in accordance with an embodiment of the present invention.

FIG. 8A illustrates practical working waveforms of the circuits shown in FIG. 6 in accordance with an embodiment of the present invention.

FIG. 8B schematically illustrates curves indicating the relationship between the offset signal Voffset and the freewheeling time FRT in practical applications.

FIG. 9 is a flow chart of a zero current detection method used in switching converters in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

To solve the problem addressed in the background, the present invention proposes a zero current detection method, wherein the offset signal used for counteracting the inherent delay is no longer fixed but variable with the on-time of the body diode in the low-side switch. This automatically adjusted offset signal can effectively reduce or even eliminate the influence caused by the delay, thus improve the accuracy of zero current detection.

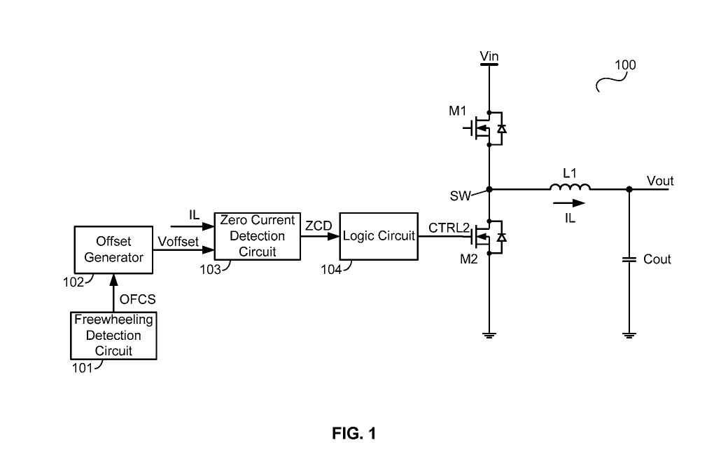

FIG. 1 is a block diagram of a switching converter 100 in accordance with an embodiment of the present invention. The switching converter 100 is configured in a synchronous BUCK converter, and includes a high-side switch M1, a low-side switch M2, an inductor L1, an output capacitor Cout, a freewheeling detection circuit 101, an offset generator 102, a zero current detection circuit 103 and a logic circuit 104. Each of the switches M1 and M2 has a gate terminal, a source terminal and a drain terminal, wherein the drain terminal of the switch M1 is configured to receive an input voltage Vin. The drain terminal of the switch M2 is coupled to the source terminal of the switch M1 to form a switch node SW. The source terminal of the switch M2 is coupled to a reference ground. The inductor L1 has a first terminal and a second terminal, wherein the first terminal is coupled to the switch node SW, and the second terminal is configured to provide an output voltage Vout to a load. The output capacitor Cout is coupled between the second terminal of the inductor L1 and the reference ground.

The freewheeling detection circuit 101 is configured to generate an offset adjusting signal OFCS in accordance with the on-time FRT (also known as freewheeling time) of the body diode in the switch M2. The freewheeling detection circuit 101 could detect the freewheeling time FRT based on the voltage across the drain and source terminals of the switch M2, and generates the offset adjusting signal OFCS accordingly. The offset generator 102 is coupled to the freewheeling detection circuit 101 and configured to generate an offset signal Voffset based on the offset adjusting signal OFCS. In an embodiment, the offset signal Voffset increases when the freewheeling time FRT decreases, and vice versa.

The zero current detection circuit 103 is coupled to the offset generator 102. It compares the current IL flowing through the inductor L1 with the offset signal Voffset and generates a zero current detection signal ZCD. The logic circuit 104 is coupled to the zero current detection circuit 103, and generates a control signal CTRL2 to turn off the switch M2 if the zero current detection signal ZCD indicates that the current IL has reduces to be smaller than the offset signal Voffset.

The freewheeling detection circuit 101, the offset generator 102, the zero current detection circuit 103 and the logic circuit 104 could be integrated in a controller, such as a control IC. The switches M1 and M2 could also be integrated therein in some embodiments.

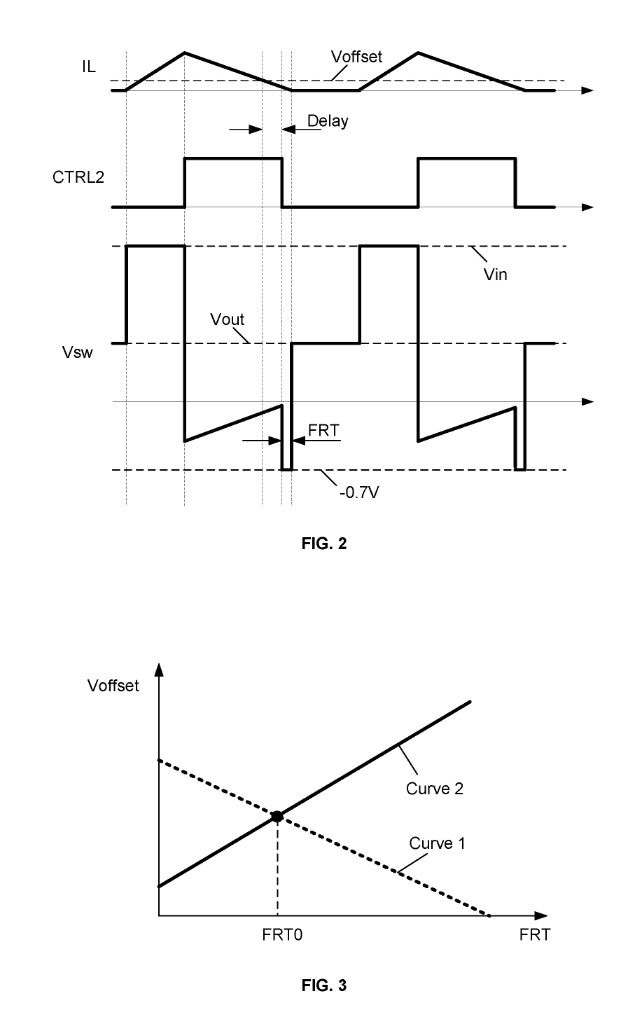

FIG. 2 illustrates working waveforms of the switching converter 100, wherein Vsw indicates the voltage at the switch node SW, i.e., the drain-source voltage of the switch M2. As shown in FIG. 2, when the switch M1 is on and the switch M2 is off, the inductor current IL increases and the voltage Vsw is equal to the input voltage Vin. When the switch M1 is off and the switch M2 is on, the inductor current IL decreases, and the voltage SW can be expressed as:

V_{sw}=−I_{L}*R_{dson} (1)

Where Rdson represents the on-resistance of the switch M2.

If the inductor current IL decreases to be lower than the offset signal Voffset, the zero current detection circuit 103 will turn off the switch M2 through the logic circuit 104 after an inherent delay (e.g. 10 nS), which could be caused by both the zero current detection circuit 103 and the logic circuit 104. Subsequently, the inductor current IL would flow through the body diode of the switch M2, and the voltage Vsw would be equal to a negative forward voltage of the body diode, for instance, −0.7V. When the inductor current IL decreases to zero, the body diode of the switch M2 also turns off, and the voltage Vsw becomes equal to the output voltage Vout. As can be seen from FIG. 2, if the offset signal Voffset decreases, the time point when the switch M2 is turned off will be postponed, and thus the freewheeling time FRT will decrease. On the contrary, the freewheeling time FRT will increase if the offset signal Voffset increases.

FIG. 3 schematically illustrates curves indicating the relationship between the offset signal Voffset and the freewheeling time FRT, wherein curve 1 illustrates the impact of the freewheeling time FRT on the offset signal Voffset, and curve 2 illustrates the impact of the offset signal Voffset on the freewheeling time FRT. According to the curves 1 and 2, when the freewheeling time FRT increases, the offset signal Voffset would decrease, and the decrease of the offset signal Voffset will further cause the freewheeling time FRT to go down, and vice versa. This forms a negative feedback loop which works to regulates the freewheeling time FRT to a value FRTO corresponding to the crossing point of the two curves. The gain of this negative feedback loop is determined by the slope of the curve 1. Moreover, the curve 2 doesn't start from zero because of the inherent delay.

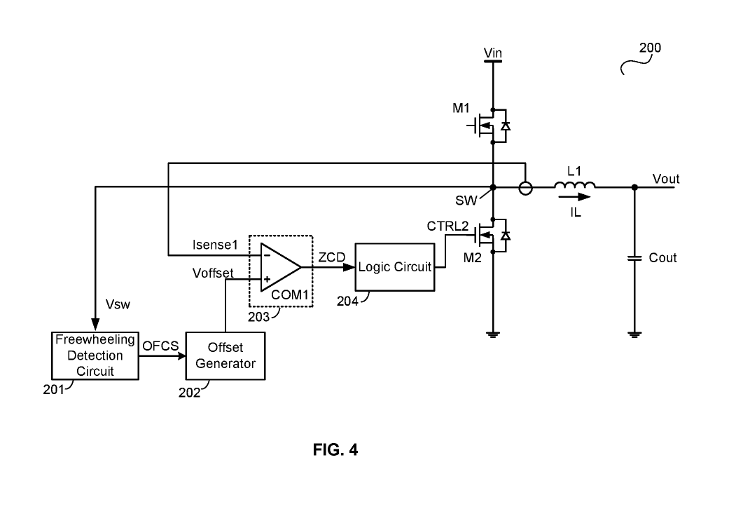

FIG. 4 is a block diagram of a switching converter 200 in accordance with an embodiment of the present invention. In this embodiment, the freewheeling detection circuit 201 is coupled to the switch node SW, and configured to detect the freewheeling time FRT and generate the offset adjusting signal OFCS based on the voltage Vsw. The zero current detection circuit 203 is coupled to the offset generator 202, and generates the zero current detection signal ZCD based on the offset signal Voffset and a current sensing signal Isense1 indicative of the inductor current IL. If the zero current detection signal ZCD indicates that the current sensing signal Isense1 is smaller than the offset signal Voffset, the logic circuit 204 will turn off the switch M2.

Sensing resistors or other suitable current sensing methods could be used to sense the inductor current IL or the current flowing through the switch M2, so as to provide the current sensing signal Isensel. Since the source-drain voltage of the switch M2, which is equal to −Vsw, is proportional to the inductor current IL when the switch M2 is on, it can also be used as the current sensing signal Isense1.

In an embodiment, the zero current detection circuit 203 comprises a comparator COM1 having a non-inverting input terminal, an inverting input terminal and an output terminal, wherein the non-inverting input terminal is coupled to the offset generator 202 to receive the offset signal Voffset, the inverting input terminal is configured to receive the current sensing signal Isesne1. The comparator COM1 compares the current sensing signal Isense1 with the offset signal Voffset and generates the zero current detection signal ZCD at the output terminal.

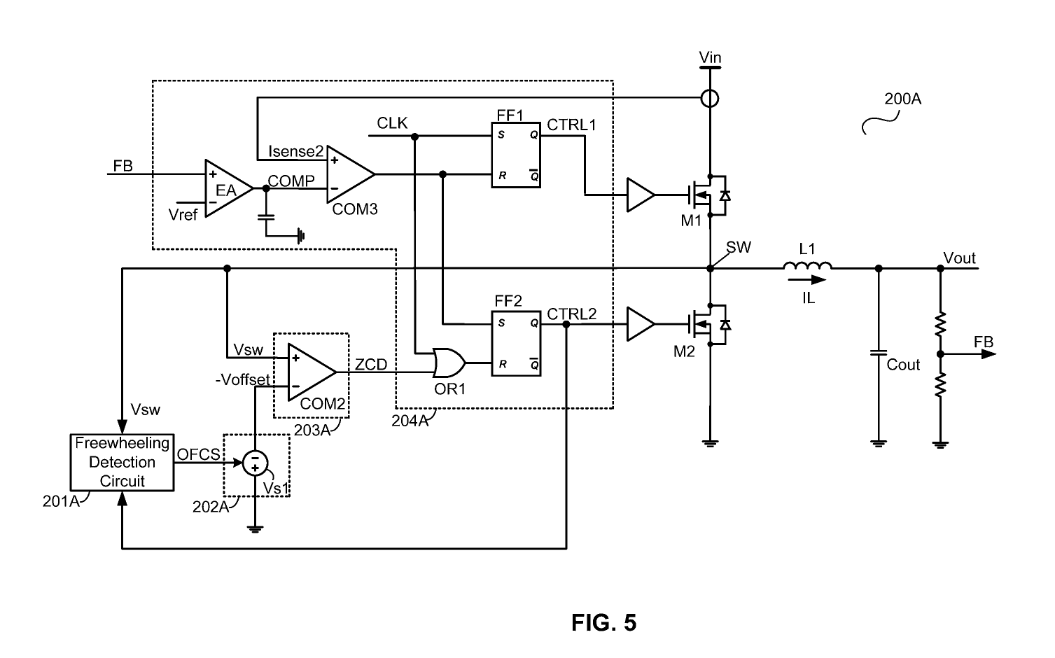

FIG. 5 schematically illustrates a switching converter 200A in accordance with an embodiment of the present invention. Coupled to the switch node SW and the logic circuit 204A, the freewheeling detection circuit 201A shown in FIG. 5 detects the freewheeling time FRT and generates the offset adjusting signal OFCS based on the voltage Vsw and the control signal CTRL2. The offset generator 202A includes a controllable voltage source which has a positive terminal, a negative terminal and a control terminal, wherein the positive terminal is coupled to the reference ground, the control terminal is coupled to the freewheeling detection circuit 201A to receive the offset adjusting signal OFCS. Based on the offset adjusting signal OFCS, the controllable voltage source Vs1 generates the offset signal Voffset across its positive and negative terminals. The zero current detection circuit 203A comprises a comparator COM2 having a non-inverting input terminal, an inverting input terminal and an output terminal, wherein the non-inverting input terminal is coupled to the switch node SW, the inverting input terminal is coupled to the negative terminal of the controllable voltage source Vs1. The comparator COM2 compares the voltage Vsw with the negative offset signal −Voffset and generates the zero current detection signal ZCD at the output terminal. If detecting the voltage Vsw increases to be higher than −Voffset, the comparator COM2 will turn off the switch M2 through the logic circuit 204A.

The logic circuit 204A could utilize any suitable control method to control the switches M1 and M2. In the embodiment shown in FIG. 5, a fixed frequency peak current control method is used and the logic circuit 204A contains an error amplifier EA, a comparator COM3, an OR gate OR1 and flip flops FF1, FF2. A feedback signal FB indicative of the output voltage Vout is compared with a reference signal Vref through the error amplifier EA. The error between these two signals is then compensated to generate a compensation signal COMP. The comparator COM3 compares a current sensing signal Isense2 indicative of the current flowing through the switch M1 with the compensation signal COMP, and generates an output signal which works with a clock signal CLK and the zero current detection signal ZCD to determine the status of the switches M1 and M2.

At the rising edge of the clock signal CLK, the switch M1 is turned on and the switch M2 is turned off. The voltage Vsw becomes equal to the input voltage Vin. The current sensing signal Isense2 as well as the inductor current IL starts to increase. Once the current sensing signal Isense2 becomes larger than the compensation signal COMP, the switch M1 is turned off and the switch M2 is turned on. The inductor current IL starts to decrease. The voltage Vsw becomes negative and increases afterwards. If the voltage Vsw increases to be higher than −Voffset, the zero current detection signal ZCD would change from logical low into logical high. Thus the flip flop FF2 will be reset to turn off the switch M2.

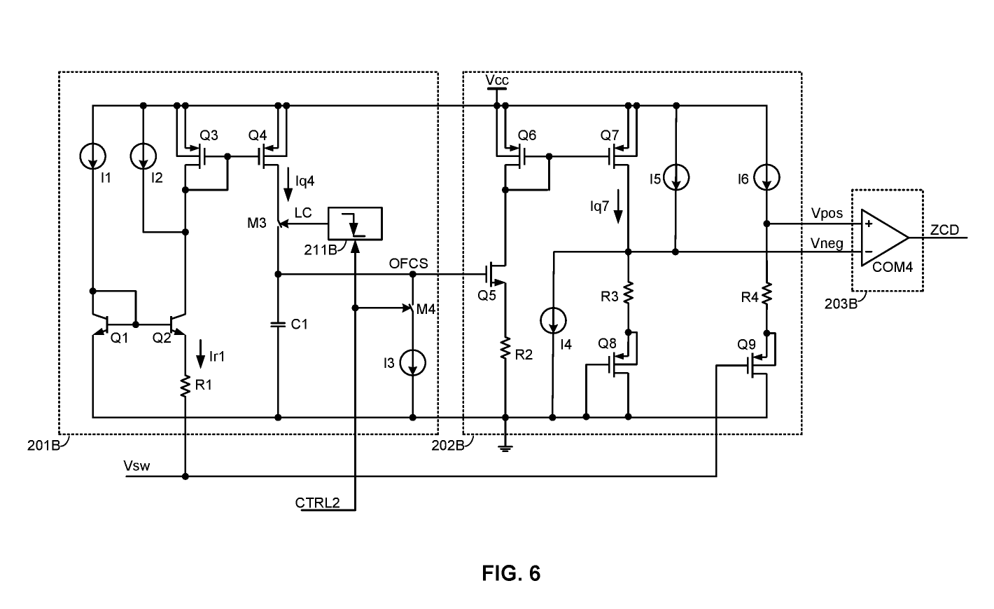

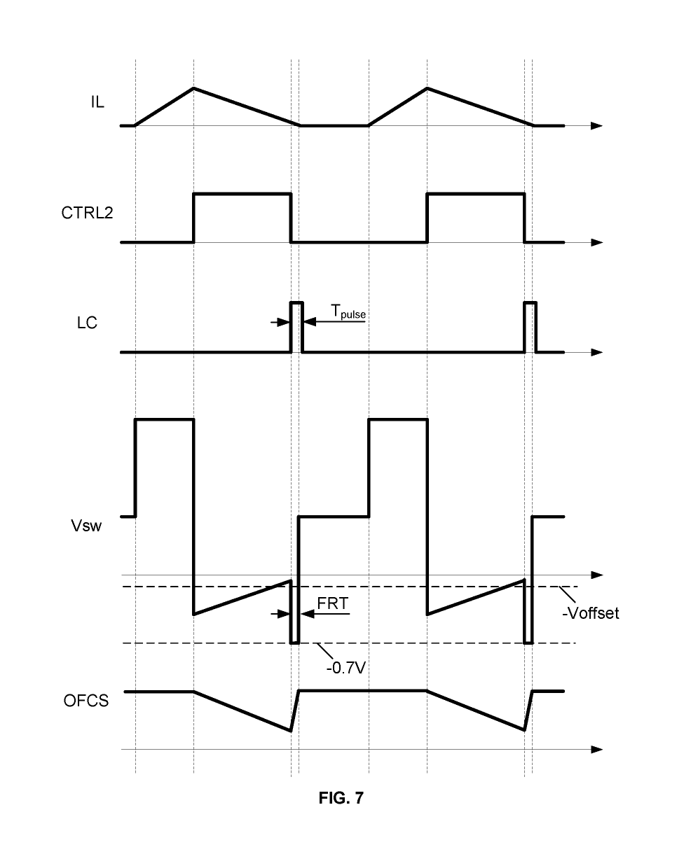

A freewheeling detection circuit 201B, an offset generator 202B and a zero current detection circuit 203B in accordance with an embodiment of the present invention are shown in FIG. 6. FIG. 7 schematically illustrates their working waveforms.

The freewheeling detection circuit 201B comprises current source I1˜13, transistors Q1-Q4, switches M3, M4, a resistor R1, a capacitor C1 and a one-shot circuit 211B. The current source I1 has a first terminal and a second terminal, wherein the first terminal is coupled to a power supply voltage Vcc. The transistor Q1 has a first terminal, a second terminal and a control terminal, wherein the first terminal and the control terminal are both coupled to the second terminal of the current source I1, the second terminal is coupled to the reference ground. The transistor Q2 has a first terminal, a second terminal and a control terminal, wherein the control terminal is couple to the control terminal of the transistor Q1. The resistor R1 has a first terminal and a second terminal, wherein the first terminal is coupled to the second terminal of the transistor Q2, the second terminal is coupled to the switch node SW to receive the voltage Vsw. The current source I2 has a first terminal and a second terminal, wherein the first terminal is coupled to the power supply voltage Vcc. The transistor Q3 has a first terminal, a second terminal and a control terminal, wherein the first terminal is coupled to the power supply voltage Vcc, the second terminal and the control terminal are both coupled to the second terminal of the current source I2 and the first terminal of the transistor Q2. The transistor Q4 has a first terminal, a second terminal and a control terminal, wherein the first terminal is coupled to the power supply voltage Vcc, the control terminal is coupled to the control terminal of the transistor Q3. The switch M3 has a first terminal, a second terminal and a control terminal, wherein the first terminal is coupled to the second terminal of the transistor Q4. The one-shot circuit 211B has an input terminal and an output terminal, wherein the input terminal is coupled to the logic circuit to receive the control signal CTRL2, the output terminal is coupled to the control terminal of the switch M3. Based on the control signal CTRL2, the one-shot circuit 211B generates a logic control signal LC at the output terminal. The capacitor C1 has a first terminal and a second terminal, wherein the first terminal is coupled to the second terminal of the switch M3 and provides the offset adjusting signal OFCS, the second terminal is coupled to the reference ground. The switch M4 has a first terminal, a second terminal and a control terminal, wherein the first terminal is coupled to the first terminal of the capacitor C1, the control terminal is coupled to the logic circuit to receive the control signal CTRL2. The current source I3 has a first terminal and a second terminal, wherein the first terminal is coupled to the second terminal of the switch M4, the second terminal is coupled to the reference ground.

The offset generator 202B comprises transistors Q5-Q9, resistors R2˜R4 and current source I4˜16. The transistor Q5 has a first terminal, a second terminal and a control terminal, wherein the control terminal is coupled to the freewheeling detection circuit 201B to receive the offset adjusting signal OFCS. The resistor R2 has a first terminal and a second terminal, wherein the first terminal is coupled to the second terminal of the transistor Q5, the second terminal is coupled to the reference ground. The transistor Q6 has a first terminal, a second terminal and a control terminal, wherein the first terminal is coupled to the power supply voltage Vcc, the second terminal and the control terminal are both coupled to the first terminal of the transistor Q5. The transistor Q7 has a first terminal, a second terminal and a control terminal, wherein the first terminal is coupled to the power supply voltage Vcc, the control terminal is coupled to the control terminal of the transistor Q6. The current source I4 has a first terminal and a second terminal, wherein the first terminal is coupled to the second terminal of the transistor Q7, the second terminal is coupled to the reference ground. The current source I5 has a first terminal and a second terminal, wherein the first terminal is coupled to the power supply voltage Vcc, the second terminal is coupled to the second terminal of the transistor Q7 and the first terminal of the current source I4. The resistor R3 has a first terminal and a second terminal, wherein the first terminal is coupled to the second terminal of the current source I5. The transistor Q8 has a first terminal, a second terminal and a control terminal, wherein the first terminal is coupled to the second terminal of the resistor R3, the second terminal and the control terminal are both coupled to the reference ground. The current source I6 has a first terminal and a second terminal, wherein the first terminal is coupled to the power supply voltage Vcc. The resistor R4 has a first terminal and a second terminal, wherein the first terminal is coupled to the second terminal of the current source I6. The transistor Q9 has a first terminal, a second terminal and a control terminal, wherein the first terminal is coupled to the second terminal of the resistor R4, the second terminal is coupled to the reference ground, and the control terminal is coupled to the switch node SW to receive the voltage Vsw.

The zero current detection circuit 203B comprises a comparator COM4 having a non-inverting input terminal, an inverting input terminal and an output terminal, wherein the non-inverting input terminal is coupled to the first terminal of the resistor R4 to receive a voltage Vpos, the inverting input terminal is coupled to the first terminal of the resistor R3 to receive a voltage Vneg, and the output terminal is configured to provide the zero current detection signal ZCD.

In the freewheeling detection circuit 201B shown in FIG. 6, the resistor R1 senses the voltage Vsw and converts it into a current Ir1. During the freewheeling time FRT, the current Ir1 could be expressed as:

$${I}_{r 1} = \frac{{V}_{fd}}{{R}_{1}} + {I}_{1} \qquad ( 2 )$$

Where Vfd indicates the forward voltage of the body diode in the low-side switch M2.

The transistor Q3 and Q4 work together to form a current mirror. If the current output by the current source I1 and I2 are equal, the current Iq4 flowing through the transistor Q4 can be expressed as:

$${I}_{q 4} = {I}_{r 1} - {I}_{2} = \frac{{V}_{fd}}{{R}_{1}} \qquad ( 3 )$$

It should be noted that the equations (2) and (3) are only applicable during the freewheeling time FRT. When the voltage Vsw is larger than zero, there is no current flowing through the resistor R1. Thus the current Ir1 and Iq4 would both be zero.

The one-shot circuit 211B is triggered when the low-side switch M2 is turned from on to off. A pulse signal is generated consequently to turn on the switch M3 for a while. The pulse width Tpulse of the pulse signal is generally configured to be longer than the freewheeling time FRT and sufficient to blank the ringing on the voltage Vsw. Since the capacitor C1 is only charged when the switch M3 is on, the charges charged to the capacitor C1 could be expressed as:

$${QC}_{1} = {I}_{q 4} * {T}_{pulse} = \frac{{V}_{fd}}{{R}_{1}} * F R T \qquad ( 4 )$$

The capacitor C1 is discharged when the low-side switch M2 is on, and the charges discharged could be expressed as:

QC₂=I₃*T_{LSON} (5)

Where TLSON represents the on-time of the low-side switch M2.

Regarding the offset generator 202B, the transistors Q8 and Q9 therein are both configured as source followers, and work with the current source I5, I6 and the resistors R3, R4 to form a level shift circuit. The current provided by the current source I5 and I6 are equal, and the resistors R3, R4 have the same resistance.

The voltage Vneg at the inverting input terminal of the comparator COM4 is:

V_{neg}=(I₅+I_{q7}−I₄)*R₃ (6)

Where Iq7 indicates the current flowing through the transistor Q7. The voltage Vpos at the non-inverting input terminal of the comparator COM4 is:

Vₚₒₛ=I₆*R₆+V_{sw} (7)

Comparing the voltage Vpos with Vneg, the comparator COM4 in fact compares Vsw with (Iq7-I4)*R3. Further referring to FIG. 5, the offset signal Voffset can be expressed as:

V_{offset}=(I₄-I_{q7})*R₃ (8)

According to FIG. 6, if the freewheeling time FRT increases, the voltage across the capacitor C1, i.e., the offset adjusting signal OFCS, will increase. The current Iq7 flowing through the transistor Q7 will also increase and lead to a decrease of the offset signal Voffset. Similarly, if the freewheeling time FRT decreases, the offset adjusting signal OFCS and the current Iq7 will both decrease and cause an increase of the offset signal Voffset.

Thanks to the negative feedback loop, the charges QC1 and QC2 would become equal. So based on equations (4) and (5), we can get the freewheeling time FRT will finally be regulated to a relatively small value, which can be expressed as:

$$F R {T}_{0} = \frac{{I}_{3} * {T}_{LSON} * {R}_{1}}{{V}_{fd}} \qquad ( 9 )$$

For the circuit shown in FIG. 6, the capacitor C1 does not need a large capacitance because the ramp on its voltage is actually used as a slope compensation of the negative feedback loop. Moreover, the switch M4 can also be controlled in other suitable scheme except being turned on only when the low-side switch M2 is on.

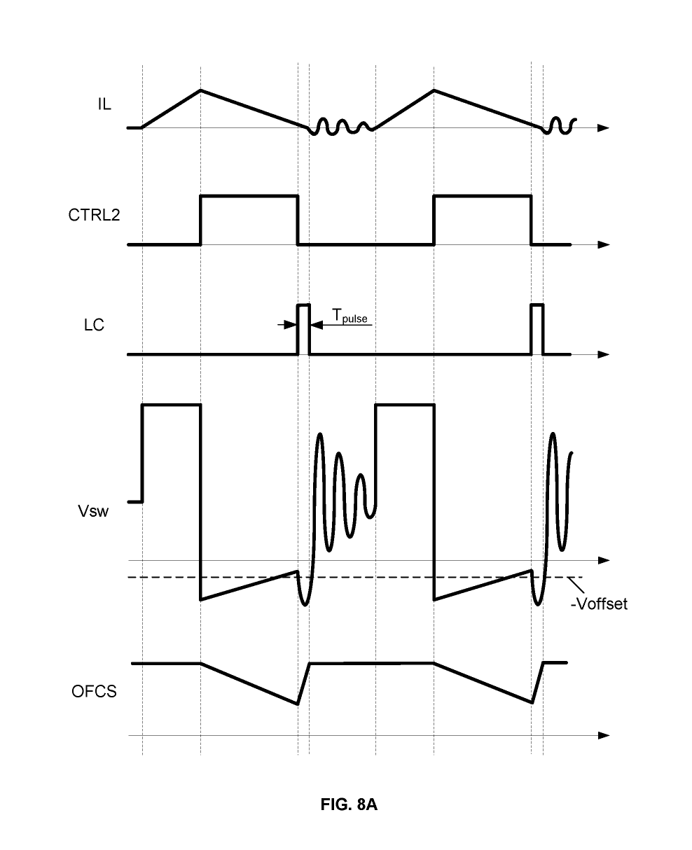

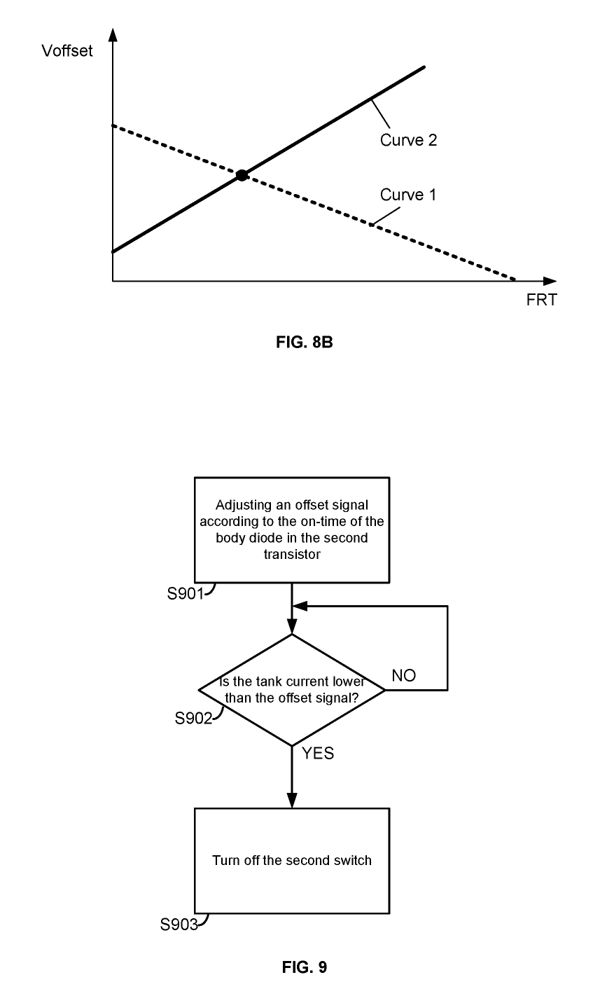

In practical applications, if the freewheeling time FRT is too short, the voltage Vsw probably cannot reach −Vfd because of the parasitic capacitor. In this situation, the voltage Vsw would have a waveform like that shown in FIG. 8A, and the charge QC1 can be expressed as:

QC₁=I_{q4}*Tₚᵤₗₛₑ=f(FRT)*Tₚᵤₗₛₑ (10)

The charge QC1 would also rises up along with an increase of the freewheeling time FRT. Consequently, the negative feedback loop mentioned before could still work. Yet the slope of the curve 1 would be different from that of FIG. 3, as can be seen from FIG. 8B.

Although switching converters in the embodiments described above are all configured in BUCK, people of ordinary skill in the art can recognize that the present invention is also applicable to BOOST, BUCK-BOOST, FORWARD, FLYBACK and other suitable converters. Furthermore, the high-side and low-side switches in the switching converter are not limited to NMOS, and can use PMOS instead to meet the practical requirements.

FIG. 9 is a flow chart of a zero current detection method used in switching converters in accordance with an embodiment of the present invention. The switching converter includes a first switch, a second switch with a body diode and a tank element (e.g. an inductor or transformer). The current flowing through the tank element increases when the first switch is on and the second switch is off, and decreases when the first switch is off and the second switch is on. The zero current detection method contains steps S901˜S903.

At step S901, an offset signal is adjusted in accordance with the on-time of the body diode in the second switch. For instance, the offset signal could increase when the on-time of the body diode decreases, and decrease when the on-time of the body diode increases.

At step S902, the current flowing through the tank element is compared with the offset signal. If the current flowing through the tank element is detected to be lower than the offset signal, the method will proceed to step S903 to turn off the second switch.

In an embodiment, the step S902 comprises: sensing the current flowing through the tank element and generating a current sensing signal; and comparing the current sensing signal with the offset signal.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A zero current detection method used in a switching converter, wherein the switching converter has a first switch, a second switch with a body diode, and a tank element, and wherein the current flowing through the tank element increases when the first switch is on and the second switch is off, and decreases when the first switch is off and the second switch is on, the zero current detection method comprises:
adjusting an offset signal in accordance with the on-time of the body diode in the second switch;
comparing the current flowing through the tank element with the offset signal; and
turning off the second switch if the current flowing through the tank element is detected to be lower than the offset signal.

2. The zero current detection method of claim 1, wherein the offset signal increases when the on-time of the body diode decreases, and decreases when the on-time of the body diode increases.

3. The zero current detection method of claim 1, wherein the step of comparing the current flowing through the tank element with the offset signal comprises:
sensing the current flowing through the tank element and generating a current sensing signal; and
comparing the current sensing signal with the offset signal.

4. The zero current detection method of claim 3, wherein the current sensing signal is the voltage across the body diode of the second switch.

5. The zero current detection method of claim 1, wherein the on-time of the body diode increases when the offset signal increases, and decreases when the offset signal decreases.

6. A controller used in a switching converter, wherein the switching converter has a first switch, a second switch with a body diode, and a tank element, and wherein the current flowing through the tank element increases when the first switch is on and the second switch is off, and decreases when the first switch is off and the second switch is on, the controller comprises:
a freewheeling detection circuit configured to generate an offset adjusting signal in accordance with the on-time of the body diode in the second switch;
an offset generator coupled to the freewheeling detection circuit and configured to generate an offset signal based on the offset adjusting signal;
a zero current detection circuit coupled to the offset generator, wherein based on the offset signal and a current sensing signal indicative of the current flowing through the tank element, the zero current detection circuit generates a zero current detection signal; and
a logic circuit coupled to the zero current detection circuit, wherein the logic circuit turns off the second switch if the zero current detection signal indicates that the current sensing signal is smaller than the offset signal.

7. The controller of claim 6, wherein the zero current detection circuit comprises a comparator having a first input terminal, a second input terminal and an output terminal, wherein the first input terminal is configured to receive the current sensing signal, the second input terminal is coupled to the offset generator to receive the offset signal, and wherein the comparator compares the current sensing signal with the offset signal and generates the zero current detection signal at the output terminal.

8. The controller of claim 6, wherein the freewheeling detection circuit detects the on-time of the body diode and generates the offset adjusting signal based on the voltage across the body diode.

9. The controller of claim 6, wherein the current sensing signal is the voltage across the body diode of the second switch.

10. The controller of claim 6, wherein the offset signal increases when the on-time of the body diode decreases, and decreases when the on-time of the body diode increases.

11. The controller of claim 6, wherein the on-time of the body diode increases when the offset signal increases, and decreases when the offset signal decreases.

12. The controller of claim 6, wherein the switching converter is configured in one of BUCK, BOOST, BUCK-BOOST, FORWARD and FLYBACK converters.

13. The controller of claim 6, wherein the tank element is an inductor or a transformer.

14. A switching converter comprising:
a first switch having a first terminal, a second terminal and a control terminal, wherein the first terminal is configured to receive an input voltage;
a second switch with a body diode, wherein the second switch has a drain terminal, a source terminal and a gate terminal, the drain terminal is coupled to the second terminal of the first switch to form a switch node, the source terminal is coupled to a reference ground;
an inductor having a first terminal and a second terminal, wherein the first terminal is coupled to the switch node, and the second terminal is configured to provide an output voltage to a load;
an output capacitor coupled between the second terminal of the inductor and the reference ground;
a freewheeling detection circuit configured to generate an offset adjusting signal in accordance with the on-time of the body diode in the second switch;
an offset generator coupled to the freewheeling detection circuit and configured to generate an offset signal based on the offset adjusting signal;
a zero current detection circuit coupled to the offset generator, wherein based on the offset signal and a current sensing signal indicative of the current flowing through the inductor, the zero current detection circuit detects whether the current flowing through the inductor decreases to zero and generates a zero current detection signal; and
a logic circuit coupled to the zero current detection circuit, wherein if the zero current detection signal indicates that the current flowing through the inductor decreases to zero, the logic circuit will generate a control signal to turn off the second switch.

15. The switching converter of claim 14, wherein the zero current detection circuit comprises a comparator having a first input terminal, a second input terminal and an output terminal, wherein the first input terminal is coupled to the switch node, the second input terminal is coupled to the offset generator to receive a negative offset signal, and wherein the comparator compares the voltage at the switch node with the negative offset signal and generates the zero current detection signal at the output terminal.

16. The switching converter of claim 14, wherein the freewheeling detection circuit detects the on-time of the body diode and generates the offset adjusting signal based on the control signal and the voltage at the switch node.

17. The switching converter of claim 14, wherein the offset signal increases when the on-time of the body diode decreases, and decreases when the on-time of the body diode increases.

18. The switching converter of claim 14, wherein the freewheeling detection circuit comprises:
a first current source having a first terminal and a second terminal, wherein the first terminal is coupled to a power supply voltage;
a first transistor having a first terminal, a second terminal and a control terminal, wherein the first terminal and the control terminal are both coupled to the second terminal of the first current source, the second terminal is coupled to the reference ground;
a second transistor having a first terminal, a second terminal and a control terminal, wherein the control terminal is couple to the control terminal of the first transistor;
a first resistor having a first terminal and a second terminal, wherein the first terminal is coupled to the second terminal of the second transistor, the second terminal is coupled to the switch node;
a second current source having a first terminal and a second terminal, wherein the first terminal is coupled to the power supply voltage;
a third transistor having a first terminal, a second terminal and a control terminal, wherein the first terminal is coupled to the power supply voltage, the second terminal and the control terminal are both coupled to the second terminal of the second current source and the first terminal of the second transistor;
a fourth transistor having a first terminal, a second terminal and a control terminal, wherein the first terminal is coupled to the power supply voltage, the control terminal is coupled to the control terminal of the third transistor;
a third switch having a first terminal, a second terminal and a control terminal, wherein the first terminal is coupled to the second terminal of the fourth transistor;
a one-shot circuit having an input terminal and an output terminal, wherein the input terminal is coupled to the logic circuit to receive the control signal, the output terminal is coupled to the control terminal of the third switch, and wherein based on the control signal, the one-shot circuit generates a logic control signal at the output terminal;
a capacitor having a first terminal and a second terminal, wherein the first terminal is coupled to the second terminal of the third switch and provides the offset adjusting signal, the second terminal is coupled to the reference ground;
a fourth switch having a first terminal, a second terminal and a control terminal, wherein the first terminal is coupled to the first terminal of the capacitor, the control terminal is coupled to the logic circuit to receive the control signal; and
a third current source having a first terminal and a second terminal, wherein the first terminal is coupled to the second terminal of the fourth switch, the second terminal is coupled to the reference ground.

19. The switching converter of claim 14, wherein the offset generator comprises:
a fifth transistor having a first terminal, a second terminal and a control terminal, wherein the control terminal is coupled to the freewheeling detection circuit to receive the offset adjusting signal;
a second resistor having a first terminal and a second terminal, wherein the first terminal is coupled to the second terminal of the fifth transistor, the second terminal is coupled to the reference ground;
a sixth transistor having a first terminal, a second terminal and a control terminal, wherein the first terminal is coupled to a power supply voltage, the second terminal and the control terminal are both coupled to the first terminal of the fifth transistor;
a seventh transistor having a first terminal, a second terminal and a control terminal, wherein the first terminal is coupled to the power supply voltage, the control terminal is coupled to the control terminal of the sixth transistor;
a fourth current source having a first terminal and a second terminal, wherein the first terminal is coupled to the second terminal of the seventh transistor, the second terminal is coupled to the reference ground;
a fifth current source having a first terminal and a second terminal, wherein the first terminal is coupled to the power supply voltage, the second terminal is coupled to the second terminal of the seventh transistor and the first terminal of the fourth current source;
a third resistor having a first terminal and a second terminal, wherein the first terminal is coupled to the second terminal of the fifth current source;
an eighth transistor having a first terminal, a second terminal and a control terminal, wherein the first terminal is coupled to the second terminal of the third resistor, the second terminal and the control terminal are both coupled to the reference ground;
a sixth current source having a first terminal and a second terminal, wherein the first terminal is coupled to the power supply voltage;
a fourth resistor having a first terminal and a second terminal, wherein the first terminal is coupled to the second terminal of the sixth current source; and
a ninth transistor having a first terminal, a second terminal and a control terminal, wherein the first terminal is coupled to the second terminal of the fourth resistor, the second terminal is coupled to the reference ground, and the control terminal is coupled to the switch node;
wherein the zero current detection circuit comprises a comparator having a first input terminal, a second input terminal and an output terminal, wherein the first input terminal is coupled to the first terminal of the fourth resistor, the second input terminal is coupled to the first terminal of the third resistor, and the output terminal is configured to provide the zero current detection signal.
